(19) United States
(12) Patent Application Publication
(10) Pub. No.: US 2022/0082415 A1
(43) Pub. Date: Mar. 17, 2022

(54) MASS FLOW CONTROLLER

(71) Applicant: AZBIL CORPORATION, Tokyo (JP)

(72) Inventor: Kouji YUUKI, Chiyoda-ku (JP)

(73) Assignee: AZBIL CORPORATION, Tokyo (JP)

(21) Appl. No.: 17/473,551

(22) Filed: Sep. 13, 2021

(30) Foreign Application Priority Data
Sep. 14, 2020 (JP) 2020-153807

(51) Int. Cl. G01F 1/36; G01F 23/14

(52) U.S. Cl. CPC G01F 1/36; G01F 23/14

(57) ABSTRACT

A mass flow controller includes a pipe through which fluid flows, a laminar element generating differential pressure between the fluid at an upstream side and the fluid at a downstream side, a differential pressure sensor measuring differential pressure between first absolute pressure of the fluid at the upstream side of the laminar element and second absolute pressure of the fluid at the downstream side thereof, an absolute pressure sensor measuring the second absolute pressure, a pressure controller controlling a valve opening of a first valve so that the second absolute pressure has a constant value, a flow rate calculator calculating a flow rate of the fluid based on the differential pressure and the second absolute pressure, and a flow rate controller controlling a valve opening of a second valve so that the value of the flow rate is equal to a flow rate setting value.

### CROSS-REFERENCE TO RELATED APPLICATIONS

The present application is based on and claims priority to Japanese Application No. 2020-153807, filed Sep. 14, 2020, the entire contents of which are incorporated herein by reference.

### BACKGROUND

### 1. Field of the Disclosure

The present disclosure relates to a mass flow controller using a differential pressure flow meter, such as a laminar flow meter.

### 2. Description of the Related Art

Laminar-flow differential-pressure mass flow controllers are fluid control devices that measure reductions in pressure when fluids pass through laminar elements, convert the measured values into the flow rates of the fluids, and control the flow rates so as to be equal to setting values (for example, refer to Japanese Patent No. 4987977 and Japanese Unexamined Patent Application Publication No. 2015-34762). The laminar-flow differential-pressure mass flow controllers are widely used in industrial fields as control devices of gas or liquid. For example, in the semiconductor industry, the downstream side of the mass flow controller is connected to a vacuum chamber to be used for control of the flow rate of etching gas or the like.

FIG. 3 is a graph indicating a result of measurement of the relationship between the flow rate of fluid and the differential pressure of the fluid between the upstream side and the downstream side of a practical laminar element. Referring to FIG. 3, reference numerals 100, 101, 102, 103, 104, 105, 106, and 107 indicate the relationship between the flow rate and the differential pressure when the pressure of the fluid at the downstream side is 1 kPaA, 5 kPaA, 10 kPaA, 20 kPaA, 40 kPaA, 60 kPaA, 80 kPaA, and 100 kPaA, respectively. Since the viscosity and the density of the fluid are varied with the variation in pressure at the downstream side, nonlinear relationship is established between the flow rate and the differential pressure when the pressure at the downstream pressure side is decreased.

FIG. 3 indicates that the laminar-flow differential-pressure mass flow controller has a problem in that flow rate-differential pressure characteristics in the laminar element are greatly varied with the variation in pressure at the downstream side. For example, as indicated in FIG. 3, the differential pressure occurring when the flow rate is set to 100 ml/min at a pressure of 1 kPaA at the downstream side is four times or more of the differential pressure occurring when the flow rate is set to 100 ml/min at a pressure of 100 kPaA at the downstream side. Accordingly, a differential pressure sensor is required to have a wide measurement range in calculation of the flow rates using the pressures at the downstream side and the differential pressures that are measured.

In addition, since the non-linearity of the flow rate-differential pressure characteristics is increased as the pressure at the downstream side is decreased, a measurement error of the pressure at the downstream side has a great influence on the conversion accuracy of the flow rate. In other words, an absolute pressure sensor that measures the pressure at the downstream side is required to have a high measurement accuracy over the wide measurement range. Since the downstream side of the mass flow controller can be connected to apparatuses in various environments, the pressure at the downstream side is varied depending on the usage environment. Accordingly, in the usage environment in which the pressure at the downstream side is greatly varied, there are cases in which it is difficult to accurately measure the flow rate from the differential pressure.

### SUMMARY

In order to resolve the above problem, it is an object of the present disclosure to provide a mass flow controller capable of accurately measuring the flow rate to enable accurate flow rate control.

A mass flow controller according to an embodiment of the present disclosure includes a pipe through which fluid to be subjected to flow rate control flows, a differential pressure generation mechanism that is arranged in the pipe and that generates differential pressure between the fluid at an upstream side and the fluid at a downstream side, a first valve that is provided in the pipe at the downstream side of the differential pressure generation mechanism, a second valve that is provided in the pipe at the upstream side of the differential pressure generation mechanism, a differential pressure sensor that measures differential pressure between first absolute pressure of the fluid at the upstream side of the differential pressure generation mechanism and second absolute pressure of the fluid at the downstream side of the differential pressure generation mechanism, an absolute pressure sensor that measures the second absolute pressure, a pressure controller that controls a valve opening of the first valve so that the second absolute pressure measured by the absolute pressure sensor has a constant value, a flow rate calculator that calculates a flow rate of the fluid based on the differential pressure measured by the differential pressure sensor and the second absolute pressure measured by the absolute pressure sensor, and a flow rate controller that controls a valve opening of the second valve so that the value of the flow rate calculated by the flow rate calculator is equal to a flow rate setting value.

In the mass flow controller, the differential pressure generation mechanism may be a laminar element.

According to the present disclosure, since the pressure measurement range of the absolute pressure sensor is capable of being narrowed by controlling the valve opening of the first valve so that the second absolute pressure measured by the absolute pressure sensor has a constant value to perform the measurement with high resolution, it is possible to accurately measure the second absolute pressure. In addition, since the pressure measurement range of the differential pressure sensor is capable of being narrowed by setting the second absolute pressure to a constant value to perform the measurement with high resolution in the present disclosure, it is also possible to accurately measure the differential pressure. As a result, it is possible accurately measure the flow rate to enable accurate flow rate control in the present disclosure.

### BRIEF DESCRIPTION OF THE DRAWINGS

FIG. 1 is a block diagram illustrating the configuration of a laminar-flow differential-pressure mass flow controller according to an embodiment of the present disclosure;

FIG. 2 is a block diagram illustrating an exemplary configuration of a computer realizing the laminar-flow differential-pressure mass flow controller according to the embodiment of the present disclosure; and

FIG. 3 is a graph indicating the relationship between flow rates of fluid and differential pressures of the fluid between an upstream side and a downstream side.

### DETAILED DESCRIPTION

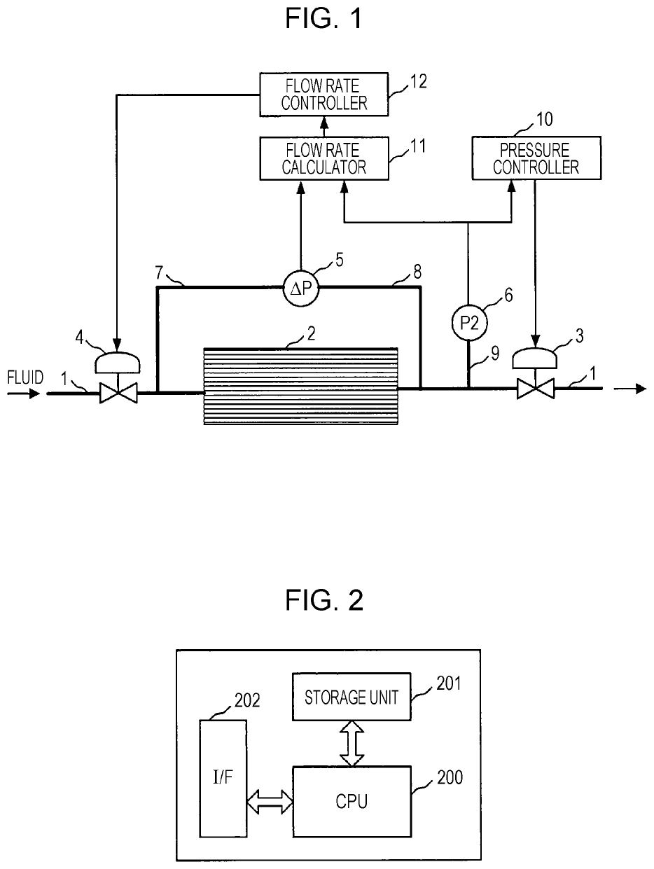

An embodiment of the present disclosure will herein be described with reference to the drawings. FIG. 1 is a block diagram illustrating the configuration of a laminar-flow differential-pressure mass flow controller according to the embodiment of the present disclosure. The laminar-flow differential-pressure mass flow controller includes a pipe 1, a laminar element 2, valves 3 and 4, a differential pressure sensor 5, an absolute pressure sensor 6, conduits 7, 8, and 9, a pressure controller 10, a flow rate calculator 11, and a flow rate controller 12. Fluid to be subjected to flow rate control flows through the pipe 1. The laminar element 2 is a differential pressure generation mechanism that is arranged in the pipe 1 and that generates the differential pressure between the fluid at the upstream side and the fluid at the downstream side. The valve 3 is provided in the pipe 1 at the downstream side of the laminar element 2. The valve 4 is provided in the pipe 1 at the upstream side of the laminar element 2. The differential pressure sensor 5 measures differential pressure ΔP (=P1−P2) between absolute pressure P1 of the fluid at the upstream side of the laminar element 2 and absolute pressure P2 of the fluid at the downstream side of the laminar element 2. The absolute pressure sensor 6 measures the absolute pressure P2. The conduits 7 and 8 lead the fluid to the differential pressure sensor 5. The conduit 9 leads the fluid to the absolute pressure sensor 6. The pressure controller 10 controls the valve opening of the valve 3 so that the absolute pressure P2 has a constant value. The flow rate calculator 11 calculates the flow rate of the fluid based on the differential pressure ΔP measured by the differential pressure sensor 5 and the absolute pressure P2 measured by the absolute pressure sensor 6. The flow rate controller 12 controls the valve opening of the valve 4 so that the value of the flow rate calculated by the flow rate calculator 11 is equal to a flow rate setting value.

For example, a semiconductor piezoresistive pressure sensor or an electrostatic pressure sensor may be used as each of the differential pressure sensor 5 and the absolute pressure sensor 6.

The laminar element 2 may have a configuration in which metal thin films are laminated. In the laminar element 2 having this configuration, a flow channel having a rectangular cross section is capable of being formed by laminating other metal thin films on and under the metal thin film in which an opening for the flow channel is formed through etching processing or the like. Since the height of the flow channel is dependent on the thicknesses of the metal thin films in the laminar element, the laminar element is characterized in that the flow channel having a uniform height is easily manufactured, compared with a case in which common processing is used. In addition, the flow rate range is easily adjusted by varying the number of the laminated films of the flow channel formed of the metal thin films. However, another laminar element may be used in the embodiment of the present disclosure.

The pressure controller 10 controls the valve opening of the valve 3 so that the absolute pressure P2 measured by the absolute pressure sensor 6 is equal to a predetermined pressure setting value. The downstream pressure between the laminar element 2 and the valve 3 is controlled so as to have a constant value.

The flow rate calculator 11 calculates a flow rate Q of the fluid based on the differential pressure ΔP measured by the differential pressure sensor 5 and the absolute pressure P2 measured by the absolute pressure sensor 6 according to Equation (1):

Q=K×(ΔP+2×P2)×ΔP (1)

In Equation (1), K denotes the constant concerning the physical property of the fluid and the shape of the flow channel. Equation (1) is based on the premise that the laminar element 2 is used as the differential pressure generation mechanism.

The flow rate controller 12 controls the valve opening of the valve 4 so that the value of the flow rate Q calculated by the flow rate calculator 11 is equal to a predetermined flow rate setting value.

In the present embodiment, the provision of the valve 3 for pressure control at the downstream side enables the flow rate control while controlling the pressure at the downstream side so as to have an arbitrary value in disregard of the influence of the variation in pressure at the downstream side of the mass flow controller. Accordingly, the measurement range of the absolute pressure sensor 6 is capable of being designed to an appropriate range within the control range of the pressure at the downstream side in the present embodiment. Consequently, since the pressure measurement range of the absolute pressure sensor 6 is capable of being narrowed to perform the measurement with high resolution, it is possible to accurately measure the absolute pressure P2 without using an accurate pressure sensor.

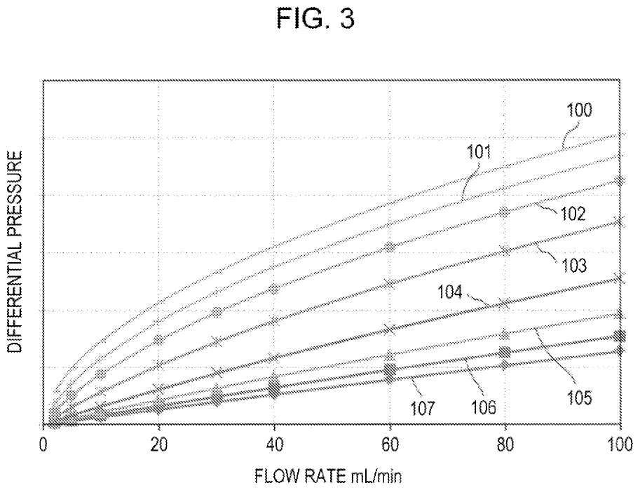

As apparent from the relationship of the flow rate-differential pressure characteristics illustrated in FIG. 3, the flow rate-differential pressure characteristics are also fixed when the pressure at the downstream side is fixed to an arbitrary pressure range. In other words, since the pressure measurement range of the differential pressure sensor 5 is capable of being narrowed to perform the measurement with high resolution, it is possible to accurately measure the differential pressure ΔP.

Accordingly, since the differential pressure ΔP and the absolute pressure P2 are capable of being accurately measured in the present embodiment, it is possible to accurately measure the flow rate to enable accurate flow rate control.

The pressure controller 10, the flow rate calculator 11, and the flow rate controller 12 described in the present embodiment are capable of being realized by a computer including a central processing unit (CPU), a storage unit, and an interface and a program that controls these hardware resources. An example of the configuration of the computer is illustrated in FIG. 2.

The computer includes a CPU 200, a storage unit 201, and an interface unit (I/F) 202. The valves 3 and 4, the differential pressure sensor 5, the absolute pressure sensor 6, and so on are connected to the I/F 202. The program for realizing a flow rate controlling method of an embodiment of the present disclosure in such a computer is stored in the storage unit 201. The CPU 200 performs the processing described in the present embodiment in accordance with the program stored in the storage unit 201.

The present disclosure is applicable to a mass flow controller.

What is claimed is:

1. A mass flow controller comprising:
a pipe through which fluid to be subjected to flow rate control flows;
a differential pressure generation mechanism that is arranged in the pipe and that generates differential pressure between the fluid at an upstream side and the fluid at a downstream side;
a first valve that is provided in the pipe at the downstream side of the differential pressure generation mechanism;
a second valve that is provided in the pipe at the upstream side of the differential pressure generation mechanism;
a differential pressure sensor that measures differential pressure between first absolute pressure of the fluid at the upstream side of the differential pressure generation mechanism and second absolute pressure of the fluid at the downstream side of the differential pressure generation mechanism;
an absolute pressure sensor that measures the second absolute pressure;
a pressure controller that controls a valve opening of the first valve so that the second absolute pressure measured by the absolute pressure sensor has a constant value;
a flow rate calculator that calculates a flow rate of the fluid based on the differential pressure measured by the differential pressure sensor and the second absolute pressure measured by the absolute pressure sensor; and
a flow rate controller that controls a valve opening of the second valve so that the value of the flow rate calculated by the flow rate calculator is equal to a flow rate setting value.

2. The mass flow controller according to claim 1,
wherein the differential pressure generation mechanism is a laminar element.
